(19) United States
(12) Patent Application Publication
(10) Pub. No.: US 2008/0119088 A1
(43) Pub. Date: May 22, 2008

(54) SHIELD CONNECTOR AND SHIELD CONNECTOR SET HAVING THE SAME

(76) Inventors: Yong-Joon Noh, Guri-si (KR); Bok-Hee Youn, Nam-gu (KR); Kyung-Hoon Park, Suwon-si (KR); Ji-Tak Nam, Seoul (KR)

Correspondence Address: STROOCK & STROOCK & LAVAN LLP, 180 MAIDEN LANE, NEW YORK, NY, 10038, US

(21) Appl. No.: 11/936,684

(22) Filed: Nov. 7, 2007

(30) Foreign Application Priority Data
Nov. 8, 2006 (KR) 10-2006-110090

(51) Int. Cl. H01R 9/03

(52) U.S. Cl. 439/610

(57) ABSTRACT

A shield connector set includes first and second connectors coupled with each other. The first connector includes a connection terminal having a connection unit connected to an exposed central line of a shield cable and a terminal head for receiving a conductive matter from outside; a connection member installed to an exposed shield layer; an inner housing for receiving the connection unit and having a central line protecting unit and a terminal fixing unit; and a shield shell for fixing the inner housing and the shield cable. The second connector includes a corresponding connection terminal connected to a core line of a cable and inserted into the terminal head, respectively; a corresponding inner housing having a hollow capable of receiving the corresponding connection terminal and the cable therein; and a corresponding shield shell having a hollow capable of receiving the corresponding inner housing therein.

### BACKGROUND OF THE INVENTION

1. Field of the Invention

The present invention relates to a shield connector and a shield connector set having the same, and more particularly to a shield connector that may be easily manufactured and easily connected to a shield cable, and a shield connector set having the same.

2. Description of the Related Art

In recent, along with the electronic trends of vehicles, a lot of electronic parts and sensors are used. A lot of electronic parts and sensors generate electric signals concurrently in a bundle. Also, the signals are transmitted to a control device or a drive device through a lot of signal lines. In this procedure, electromagnetic waves may be irregularly generated due to the electronic signals. If such electromagnetic waves are transmitted directly or indirectly to signal lines or electronic devices, the electronic devices may abnormally operate, which would be dangerous to a driver.

To prevent the above problem, a shield cable is generated used for a harness of a vehicle. The shield cable includes a central line made of a conductor, an inner coating surrounding the central line, a shield layer formed by surrounding an outside of the inner coating with braided yarns, and a sheath formed on an outside of the shield layer. Here, the shield layer made of conductive material absorbs noises generated from outside to prevent the noises from penetrating into the central line that transmits signals.

In addition, in case the shield cable is connected to an electronic device or another kind of cable using a connector without any separate shielding member, noises generated from outside may give an influence on a contact point. Thus, in order to connect the shield cable to an electronic device or another kind of cable, a shield connector configured to be capable of preventing external noises from penetrating into a contact point should be used.

The shield connector includes a connector housing and a shield shell coupled to an inner or outer portion of the connector housing. The shield shell is made of metal material in a plate shape, and the shield shell is connected to the shield layer of the shield cable to intercept noises generated from outside. In addition, the shield shell is generally made of die-casting material to simplify a contact structure with the shield cable.

Further, in case the shield cable is connected to another cable (that may be a shield cable or another kind of cable), the cables are connected to connectors with male and female structures, and then the pair of connectors connected to the cables are coupled with each other. Here, since the shield shell is made of die-casting material as mentioned above, it is difficult that the shield shells provided to the pair of connectors are closely connected. As a result, an electric contact between the shield shells provided to the pair of connectors is not kept stably, and noises generated from outside may penetrate into the shield connector.

### SUMMARY OF THE INVENTION

The present invention is designed to solve the problems of the prior art, and therefore it is an object of the present invention to provide a shield connector configured to allow each connection to a shield cable and also easy production, and a shield connector set having the same.

Another object of the present invention is to provide a shield connector capable of completely intercepting noises generated from outside by stably keeping an electric connection between shield shells of a connector connected to the shield connector and a connector connected to another kind of cable.

In order to accomplish the above object, the present invention provides a shield connector for receiving a connection terminal coupled to a central line of a shield cable and protecting the central line and the connection terminal against noises generated from outside, and the shield connector includes an inner housing for receiving a central line of a shield cable and a connection terminal coupled to the central line, the inner housing fixing a part of the connection terminal; and a shield shell for receiving at least a part of the inner housing and at least a part of the shield cable, the shield shell being electrically connected to a shield layer of the shield cable.

Preferably, the shield connector further includes an outer housing provided in a cylindrical shape with openings at both ends thereof, the outer housing having a space therein such that the shield shell is inserted and fixed therein.

Preferably, the shield connector further includes an elastic contact piece mounted to a part of an outer surface of the shield shell to be elastically transformed in an outer direction thereof.

Preferably, the shield shell includes an inner housing fixing unit for fixing the inner housing; and a connection unit for receiving at least a part of the shield layer exposed out, the connection unit being made of conductive material and electrically coupled with the shield layer.

Preferably, the connection terminal includes a connection unit connected to the central line of the shield cable; and a terminal head extended from the connection unit to receive a conductive matter inserted from outside.

Preferably, the shield layer of the shield cable is connected to the shield shell using a connection member, and the connection member includes a connection ring having an inner diameter corresponding to an outer diameter of the shield layer, the connection ring partially having an outer diameter corresponding to a shortest distance between inner surfaces of the shield shell; and a compression ring having a hollow with a size capable of receiving the connection ring and the shield layer that is rolled up on the outer surface of the connection ring.

Preferably, the shield connector further includes a seal ring member having a hollow with an inner diameter corresponding to an outer diameter of the shield cable, the seal ring member having an outer diameter corresponding to an inner diameter of the shield shell.

Preferably, the shield connector further includes a stopper mounted to a part of the shield cable such that the connection member and the shield layer of the shield cable that are inserted into an inner space of the shield shell are not deviated from the inner space of the shield shell.

In another aspect of the present invention, there is also provided a shield connector, which includes a corresponding connection terminal having a core line connection unit connected to an exposed core line of a cable and a contact pin formed at an opposite end to the core line connection unit; a corresponding inner housing having a hollow capable of receiving the corresponding connection terminal and the cable therein; and a corresponding shield shell made of conductive material and having a hollow capable of receiving the corresponding inner housing therein.

Preferably, the shield connector further includes an elastic contact piece mounted to an outside of the corresponding shield shell to be elastically transformed in an outer direction thereof.

Preferably, the shield connector further includes a seal ring member having a hollow with an inner diameter corresponding to an outer diameter of the cable, the seal ring member having an outer diameter corresponding to an inner diameter of the corresponding inner housing.

Preferably, the shield connector further includes a stopper mounted to a part of the cable such that at least a core line of the cable and the corresponding connection terminal that are inserted into an inner space of the corresponding inner housing are not deviated from the inner space of the corresponding inner housing.

In another aspect of the present invention, there is also provided a shield connector set including first and second connectors that are coupled with each other, wherein the first connector includes a connection terminal having a connection unit connected to an exposed central line of a shield cable and a terminal head extended from the connection unit to receive a conductive matter inserted from outside; a connection member installed to an exposed shield layer of the shield cable; an inner housing for receiving the connection unit of the connection terminal therein, the inner housing having a central line protecting unit for intercepting an electric contact to the connection unit of the connection terminal from outside and a terminal fixing unit integrated with the central line protecting unit to insert and fix the terminal head therein; and a shield shell for fixing at least the inner housing and the shield cable to which the connection member is mounted, wherein the second connector includes a corresponding connection terminal having one end connected to a core line of a cable and the other end inserted into the terminal head; a corresponding inner housing having a hollow capable of receiving the corresponding connection terminal and the cable therein; and a corresponding shield shell having a hollow capable of receiving the corresponding inner housing therein.

Preferably, the first connector further includes an outer housing having a cylindrical shape with opening at both ends thereof, the outer housing having a space therein such that the shield shell is inserted and fixed therein.

Preferably, the second connector further includes an elastic contact piece mounted to an outside of the corresponding shield shell to be elastically transformed in an outer direction thereof, and the corresponding shield shell is partially inserted into the outer housing such that the elastic contact piece pressures an inner surface of the outer housing.

Preferably, the first connector further includes an elastic contact piece mounted to the shield shell to be elastically transformed in an outer direction of the shield shell.

Preferably, the shield shell includes an inner housing fixing unit for fixing the inner housing; and a connection unit for receiving a part of the connection member therein, the connection unit being contacted with the connection member.

Preferably, the outer housing has at least one fixing protrusion protruded inwards, and the shield shell has a fixing protrusion placing groove capable of receiving the fixing protrusion.

Preferably, the connection member includes a connection ring having an inner diameter corresponding to an outer diameter of the shield layer, and connection ring partially having an outer diameter corresponding to a shortest distance between inner surfaces of the shield shell; and a compression ring having a hollow capable of receiving the connection ring and the shield layer that is rolled up on the outer surface of the connection ring.

Preferably, the first connector further includes a seal ring member having a hollow with an inner diameter corresponding to an outer diameter of the shield cable, the seal ring member having an outer diameter corresponding to an inner diameter of the shield shell, and the first connector further includes a stopper mounted to a part of the shield cable such that the shield layer of the shield cable and the connection member that are inserted into an inner space of the shield shell are not deviated from the inner space of the shield shell.

Preferably, the second connector further includes a seal ring member having a hollow with an inner diameter corresponding to an outer diameter of the cable, the seal ring member having an outer diameter corresponding to an inner diameter of the corresponding inner housing, and the second connector further includes a stopper mounted to a part of the cable such that the core line of the cable and the corresponding connection terminal that are inserted into an inner space of the corresponding inner housing are not deviated from the inner space of the corresponding inner housing.

According to the present invention, a shield connector may be easily connected to a shield connector without separately processing the shield cable or the shield connector, and also a working time required for connecting the shield connector may be shortened.

In addition, since a shield layer and a shield shell of the shield cable are electrically connected using a compression ring and a connection ring, a volume of the shield connector may be reduced.

Also, noises generated from outside may be completely intercepted since an electric connection between shield shells of first and second connectors are kept stably.

### BRIEF DESCRIPTION OF THE DRAWINGS

Other objects and aspects of the present invention will become apparent from the following description of embodiments with reference to the accompanying drawing. The accompanying drawings are just for better understanding of the present invention, so the present invention should not be interpreted to be limited to the accompanying drawings.

FIGS. 1a and 1b are exploded perspective views showing a first connector according to a first embodiment of the present invention.

FIG. 2 is a perspective view showing that a shield cable is connected to the first connector shown in FIGS. 1a and 1b.

FIG. 3 is a sectional view taken along the line III-III′ of FIG. 2.

FIG. 4 is a perspective view showing a second connector according to the first embodiment of the present invention.

FIG. 5 is a sectional view taken along the line V-V′ of FIG. 4.

FIG. 6 is a perspective view showing that the first and second connectors according to the first embodiment of the present invention are coupled.

FIG. 7 is a sectional view taken along the line VII-VII′ of FIG. 6.

FIG. 8 is an exploded perspective view showing a first connector according to a second embodiment of the present invention.

FIG. 9 is a perspective view showing that a shield cable is connected to the first connector shown in FIG. 8.

FIG. 10 is a sectional view taken along the line VIII-VIII′ of FIG. 9.

### DESCRIPTION OF THE PREFERRED EMBODIMENT

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

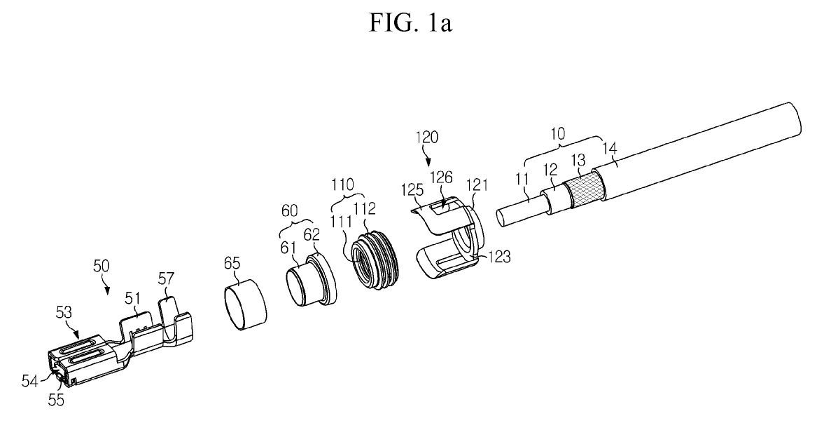

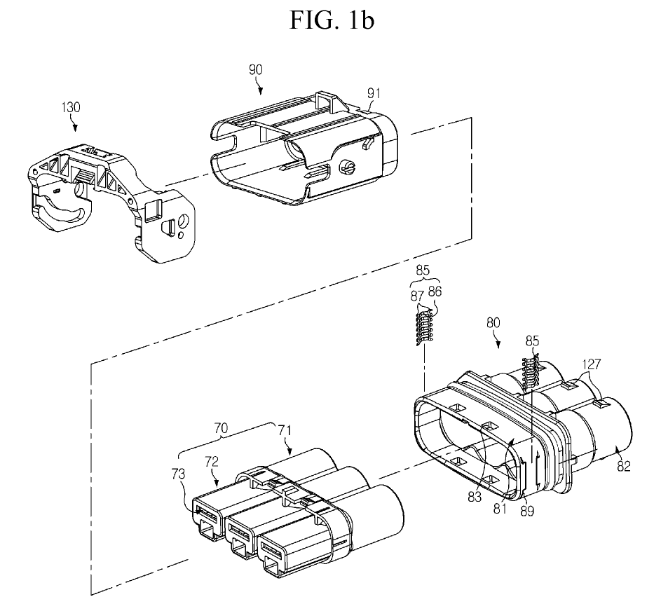

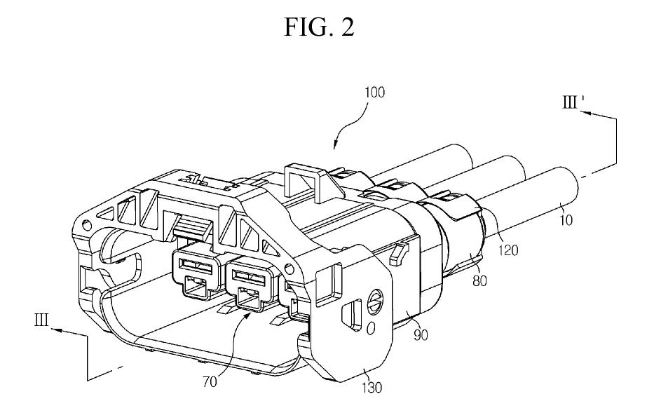

FIGS. 1a and 1b are exploded perspective views showing a first connector according to a first embodiment of the present invention, FIG. 2 is a perspective view showing that a shield cable is connected to the first connector shown in FIGS. 1a and 1b, and FIG. 3 is a sectional view taken along the line III-III′ of FIG. 2.

Referring to FIGS. 1a to 3, the first connector 100 of the first embodiment includes a connection terminal 50, a connection member 60, 65, an inner housing 70, a shield shell 80 and an outer housing 90.

The connection terminal 50 is a thin conductive plate made by cutting. The connection terminal 50 includes at one side a connection unit 51 connected by clamping to an exposed central line 11 of a shield cable and at the other end a terminal head 53 to which a terminal of an external electronic device or a central line of another cable (or, a connection terminal connected to the central line) may be connected. Here, the terminal head 53 may receive a terminal of an external electronic device or a central line of another cable (or, a connection terminal connected to the central line).

Preferably, a contact assisting means 55 may be further provided in the terminal head 53. The contact assisting means 55 is fixed in the terminal head 53 such that a part of the contact assisting means 55 is elastically transformed from one inner surface toward the other inner surface facing the inner surface.

In addition, preferably, the connection terminal 50 may further include a fixing unit 57. The fixing unit 57 is extended from the connection unit 51. The fixing unit 57 is provided in an opposite direction to the terminal head 53 based on the connection unit 51 and clamped to an inner coating 12 of the shield cable.

The connection member 60, 65 is made of conductive material and coupled to a shield layer 13 of the shield cable to keep electric connection between the shield layer 13 and the shield shell 80.

Preferably, the connection member 60, 65 may have a connection ring 69 and a compression ring 65. The connection ring 60 may be composed of a shield layer contacting unit 61 and a shield shell contacting unit 62. The shield layer contacting unit 61 has a ring shape with an inner diameter corresponding to an outer diameter of the shield layer 13. The shield shell contacting unit 62 is extended from the shield layer contacting unit 61 and has a ring shape with an outer diameter corresponding to an inner diameter of the shield shell 80 (or, a shortest distance between inner surfaces of the shield shell). Accordingly, in case the connection ring 60 is mounted to the shield layer 13 in an exposed state, an inner surface of the shield layer contacting unit 61 made of conductive material is directly contacted with the shield layer 13, and an outer surface of the shield shell contacting unit 62 made of conductive material is directly connected with an inner surface of the shield shell 80 such that the shield layer 13 and the shield shell 80 are electrically connected with each other. The compression ring 65 is a ring with an inner diameter corresponding to an outer diameter of the shield layer contacting unit 61, and it is coupled to an outside of the shield layer contacting unit 61 by compression.

Further, when the connection ring 60 and the compression ring 65 are coupled to the shield layer 13, it is possible to roll up the shield layer 13 to surround an outer surface of the connection ring 60 and then mount the compression ring 65 thereon. In this case, the inner diameter of the compression ring 65 is preferably set in consideration of the outer diameter of the shield layer contacting unit 61 and the thickness of the shield layer 13.

Though it has been illustrated in this embodiment that the connection member is composed of the connection ring 60 and the compression ring 65, the present invention is not limited thereto, but it would be sufficient if the electric connection between the shield layer 13 and the shield shell 80 is maintained.

The inner housing 70 is made of insulating material, and the inner housing 70 has a space therein capable of at least the connection terminal 50 coupled to the shield cable 10 and the exposed central line 11 of the shield cable 10. In more detail, the inner housing 70 includes a central line protecting unit 71 and a connection terminal fixing unit 72. The central line protecting unit 71 has a cylindrical shape with a hollow therein such that at least the central line 11 of the shield cable 10 to which the connection terminal 50 is mounted may pass through it. The connection terminal fixing unit 72 has an inner space communicated with the space provided in the central line protecting unit 71. This space is shaped corresponding to an outer shape of the terminal head 53 with a size capable of receiving and fixing the terminal head 53 of the connection terminal 50. In addition, the connection terminal fixing unit 72 has an opening 73 at its end such that an insert hole 54 formed in the terminal head 53 may be communicated with outside.

The shield shell 80 includes an inner housing fixing unit 81 and a connection unit 82. The inner hosing fixing unit 81 has a receiving space with a size corresponding to an external shape of the central line protecting unit 71 of the inner housing. The connection unit 82 has a hollow communicated with the receiving space prepared in the inner housing fixing unit 81, and the hollow may receive at lest the shield layer to which the connection member 60, 65 are coupled. At this time, the connection unit 82 may have an inner diameter relatively smaller than an inner diameter of the inner housing fixing unit 81. Accordingly, the inner housing 70 inserted from the opening formed in the inner housing fixing unit 81 is not inserted into the hollow prepared in the connection unit 82 but inserted and fixed just in the receiving space prepared in the inner housing fixing unit 81 due to the difference of inner diameters. When the inner housing 70 is coupled to the shield shell 80, the shield shell 80 receives just a part of the inner housing 70, namely the inner housing fixing unit 81, so the connection terminal fixing unit 72 is exposed out.

The outer housing 90 is made of insulating material with a cylindrical shape, and the outer housing 90 has a hollows successively connected to the opening at both ends thereof. The hollow has size and shape capable of receiving at least a part of the shield shell 80 coupled to the inner housing 70 (for example, the inner housing fixing unit 81).

In addition, the first connector 100 of the first embodiment may further include an elastic contact piece 85. The elastic contact piece 85 is mounted to an outer surface of the shield shell 80.

The elastic contact piece 85 includes a plurality of elastic pins 86 transformed to be protrude in one direction, and wings 87 successively connected from both ends of the plurality of elastic pins 86. The elastic contact piece 85 is inserted and fixed in a fixing groove 89 provided in the outer surface of the shield shell 80.

Preferably, the outer housing 90 may include at least one fixing protrusion 91 protruded toward the hollow, and the shield shell 80 may have a fixing protrusion placing groove 83 in which the fixing protrusion 91 may be received and placed when the shield shell 80 and the outer housing 90 are coupled.

Further, the first connector 100 of the first embodiment may further include a seal ring member 110. The seal ring member 110 is made of rubber material with elasticity to be easily transformed by an external force. The seal ring member 110 has a hollow 111 therein such that a sheath 14 of the shield cable may pass through it, and wrinkles 112 are repeatedly formed in an outer portion of the seal ring member 110. At this time, the seal ring member 110 has an outer diameter corresponding to the inner diameter of the shield shell 80. Accordingly, in case the shield cable 10 having the seal ring member 110 mounted thereto is inserted into the shield shell 80, the sheath 14 of the shield cable 10 and the inner surface of the shield shell 80 are kept airtight, thereby preventing moisture from penetrating into the hollow provided in the connection unit 82 from outside.

In addition, the first connector 100 may further include a stopper 120 coupled to the sheath 14 of the shield cable. The stopper 120 includes a fixing ring 121, a support 123, and at least one holder 125. The fixing ring 121 has a hollow with an inner diameter corresponding to the outer diameter of the sheath 14 of the shield cable. The support 123 is successively connected from one end of the fixing ring 121, and the support 123 has a doughnut shape with a hollow sized identically to the hollow of the fixing ring 121. The holder 125 is a plate connected in a vertical direction to a circumference of the outer portion of the support 123, and the holder 125 has a predetermined hole 126 therein. Meanwhile, a predetermined protrusion 127 may be provided to an outer portion of the connection unit 82. In case the shield cable 10 with the stopper 120 mounted thereto is inserted into the shield shell 80, the protrusion 127 provided to the connection unit 82 is inserted into the hole 126 provided in the holder 125, thereby keeping a coupling state between the shield cable 10 and the shield shell 80.

Though it has been illustrated in this embodiment that the support 123 has a doughnut shape, the present invention is not limited thereto, but any configuration provided between the fixing ring 121 and the holder 125 to prevent movement of the shield shell 80 may be sufficiently used.

In addition, the first connector 100 may further include a lever 130 installed to the outer housing 90 to temporarily enlarge a size of the opening of the outer housing 90.

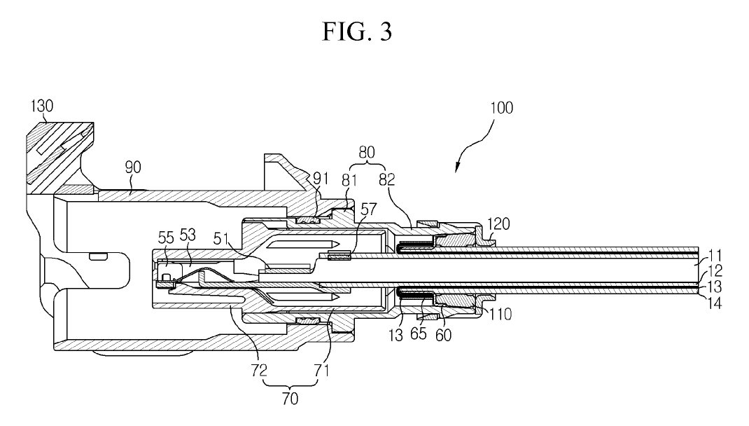

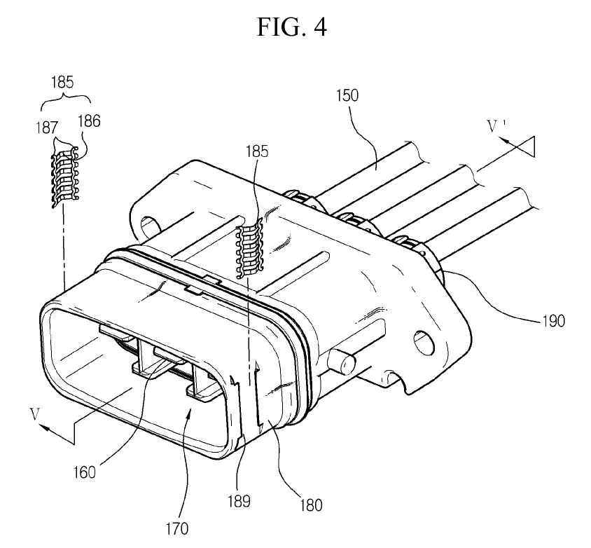

FIG. 4 is a perspective view showing a second connector according to the first embodiment of the present invention, and FIG. 5 is a sectional view taken along the line V-V′ of FIG. 4.

Referring to FIGS. 4 and 5, the second connector 200 of this embodiment is inserted and fixed in the first connector 100. The second connector 200 includes a corresponding connection terminal 160, a corresponding inner housing 170, a corresponding shield shell 180, an elastic contact piece 185, and a fixing member 190.

The corresponding connection terminal 160 is a thin conductive plate made by cutting. The corresponding connection terminal 160 includes at one side a core line connection unit 161 connected to a core line 151 of a cable 150 by clamping and at the other end a contact pin 163 provided to be inserted into the terminal head 53. In addition, the corresponding connection terminal 160 may further include a connection terminal fixing member 162 between the core line connection unit 161 and the contact pin 163. The connection terminal fixing member 162 has a hole 164 at a part thereof such that a part of the corresponding inner housing 170 may be inserted and fixed therein.

The corresponding inner housing 170 is a member for receiving and fixing the cable 150 and the corresponding connection terminal 160 therein. The corresponding inner housing 170 includes a terminal inserting unit 171, a terminal fixing unit 172 and an inner housing receiving unit 173. The terminal inserting unit 171 has an insert hole for inserting the cable 150 connected to the corresponding connection terminal 160 therein, and a through space through which the contact pin 163 and the connection terminal fixing member 162 may pass. The terminal fixing unit 172 has a space in which the connection terminal fixing member 162 of the corresponding connection terminal 160 may be received and fixed. Further, the terminal fixing unit 172 may further include a protrusion 174 inserted into the hole 164 to fix the connection terminal fixing member 162. The inner housing receiving unit 173 gives a space such that at least the connection terminal fixing unit 72 of the inner housing 70 provided to the first connector 100 may be received and fixed therein.

The corresponding shield shell 180 is made of conductive material with a cylindrical shape, like the shield shell 80. The corresponding shield shell 180 has a hollow with a size capable of receiving the corresponding inner housing 170 therein, and the corresponding shield shell 180 has outer shape and size corresponding to the inside of the outer housing 90 such that the corresponding shield shell 180 may be inserted into the outer housing 90 of the first shield connector.

The elastic contact piece 185 includes a plurality of elastic pins 186 elastically transformed to protrude in one direction, and wings 187 successively connected from both ends of the plurality of elastic pins 186. Further, the corresponding shield shell 180 may further include a fixing groove 189 in which the wings 187 of the elastic piece 185 may be inserted and fixed.

As a result, when the second connector 200 is coupled to the first connector 100, the corresponding shield shell 180 with the elastic contact piece 185 mounted thereto is inserted into the inner space of the outer housing 90, and the elastic contact piece 185 increases a coupling force between the outer housing 90 and the corresponding shield shell 180 and also keeps their elastic contact stably.

The fixing member 190 is a member for fixing the cable 150 to the corresponding inner housing 170, and includes a seal ring member 191 and a stopper 192. The seal ring member 191 and the stopper 192 are identical to the seal ring member 110 and the stopper 120 employed to the first connector 100, so they are not explained in detail here.

Preferably, the second connector 200 may further include a corresponding outer housing (not shown) that protects outer surfaces of the corresponding inner housing 170 and the corresponding shield shell 180. It would be sufficient if the corresponding outer housing has an inner space with a size capable of receiving a part of the corresponding inner housing 170 and a part of the corresponding shell 180 (or, a portion not inserted into the first connector 100) therein.

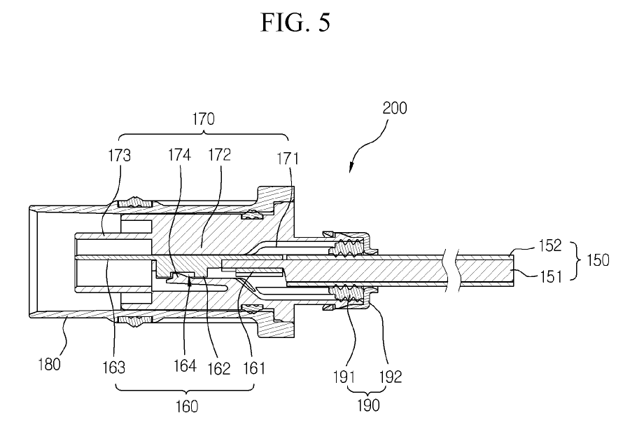

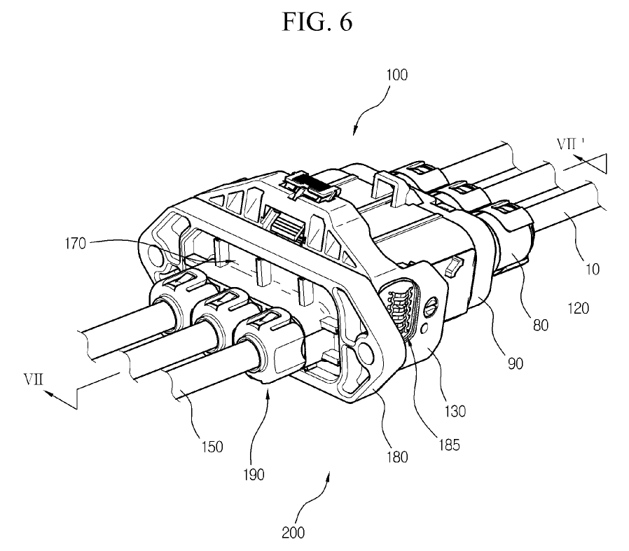

FIG. 6 is a perspective view showing that the first and second connectors according to the first embodiment of the present invention are coupled, and FIG. 7 is a sectional view taken along the line VII-VII′ of FIG. 6. In FIG. 6, the elastic contact piece 185 is inserted into the outer housing 90 and thus actually not shown, but it is shown in the figure by partially sectioning the outer housing 90 and the lever 130 for better understanding.

Hereinafter, a process of coupling the shield connector set 100, 200 according to the embodiment of the present invention will be explained with reference to FIGS. 6 and 7, based on the above components.

First, a process of coupling the first connector 100 is described.

Before the first connector 100 is coupled, the shield cable 10 is processed such that the central line 11, the inner coating 12 and the shield layer 13 are partially exposed out, respectively.

Then, the stopper 120, the seal ring member 110 and the connection member 60, 65 are inserted to an outside of the shield cable 10 in order, and then freely positioned out of the shield cable 10. Also, the central line 11 is positioned to the connection unit 51 of the connection terminal 50, and the inner coating 12 is positioned to the fixing unit 57. Then, the connection unit 51 and the fixing unit 57 are respectively clamped and coupled to the central line 11 and the inner coating 12. After that, the shield layer contacting unit 61 of the connection ring 60 is inserted to surround the shield layer 13 of the shield cable 10. At this time, the shield layer contacting unit 61 is positioned spaced apart from an end of the shield layer 13 by a predetermined distance (for example, as much as a length of the shield layer contacting unit 61). In addition, the shield layer 13 is rolled up to surround an outer surface of the shield layer contacting unit 61, and then the compression ring 65 is inserted thereon and compressed.

Meanwhile, the inner housing 70, the shield shell 80 and the outer housing 90 are coupled. In more detail, the central line protecting unit 71 of the inner housing 70 is inserted into the space formed in the inner housing fixing unit 81 of the shield shell 80, and the outer housing 90 is mounted to the shield shell 80 to which the inner housing 70 is already coupled. At this time, the fixing protrusion 91 provided to the outer housing 90 is completely placed in the fixing protrusion placing groove 83 provided to the shield shell 80. In addition, the elastic contact piece 85 may be mounted to the shield shell 80. At this time, the elastic contact piece 85 is elastically transformed toward the outer housing 90. The fixing protrusion 91, the fixing protrusion placing groove 83 and the elastic contact piece 85 may keep a stable coupling between the shield shell 80 and the outer housing 90.

Then, the shield cable in which the connection terminal 50, the connection member 60, 65, the seal ring member 110 and the stopper 120 are coupled is coupled to an assembly in which the inner housing 70, the shield shell 80 and the outer housing 90 are coupled. First, the shield cable 10 is inserted into the assembly 70, 80, 90 such that the terminal head 53 is positioned in the space provided in the connection terminal fixing unit 72, and also such that the outer surface of the shield shell contacting unit 62 is closely connected with the inner surface of the connection unit 82 of the shield shell 80. After that, the seal ring member 110 positioned out of the shield cable 10 is pushed into the connection unit 82. In addition, the stopper 120 is closely adhered to the end of the connection unit 82 and fixed thereto.

Meanwhile, seeing a coupling process of the second connector 200, the core line 151 of the cable 150 is exposed, and the seal ring member 191 and the stopper 192 are inserted into the cable 150. After that, the core line connection unit 161 of the corresponding connection terminal 160 is clamped and joined to the core line 151. In addition, the cable 150 to which the corresponding connection terminal 160 is coupled is inserted into the corresponding inner housing 170 through the terminal inserting unit 171 from the contact pin 163. At this time, the cable 150 is pushed therein such that the protrusion 174 is inserted and fixed in the hole 164. After then, the seal ring member 191 is positioned to the end of the terminal inserting unit 171 and coupled to the stopper 192. Also, the corresponding inner housing 170 is inserted and fixed in the corresponding shield shell 180.

Finally, the second connector 200 assembled as mentioned above is inserted into an end of the outer housing 90 of the first connector 100. At this time, the corresponding shield shell 180 is inserted into the outer housing 90, and the elastic contact piece 185 coupled to the corresponding shield shell 180 is elastically transformed due to an inner wall of the outer housing 90. Accordingly, the elastic contact piece 185 increases a coupling force between the outer housing 90 and the corresponding shield shell 180 and also keeps their electric contact stably.

If a shield cable is coupled with another kind of cable using the above shield connector set, it is possible to stably couple the cables and also keep an excellent shielding performance.

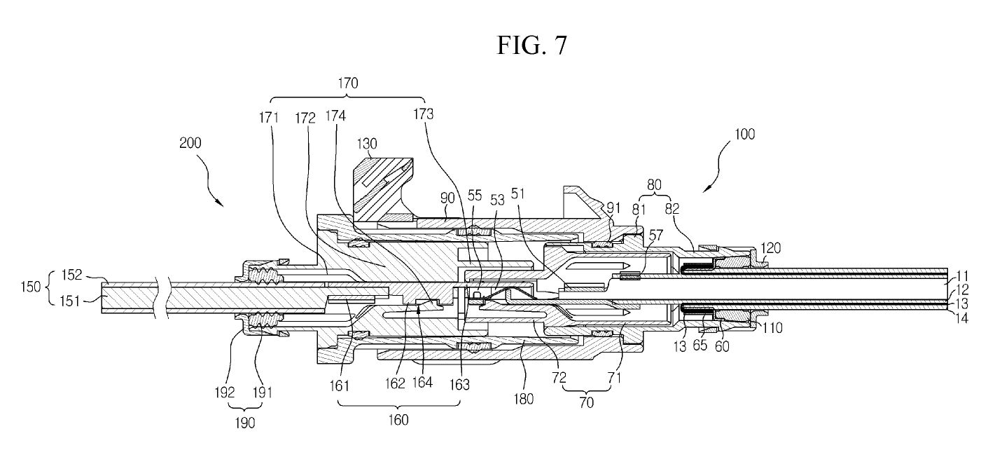

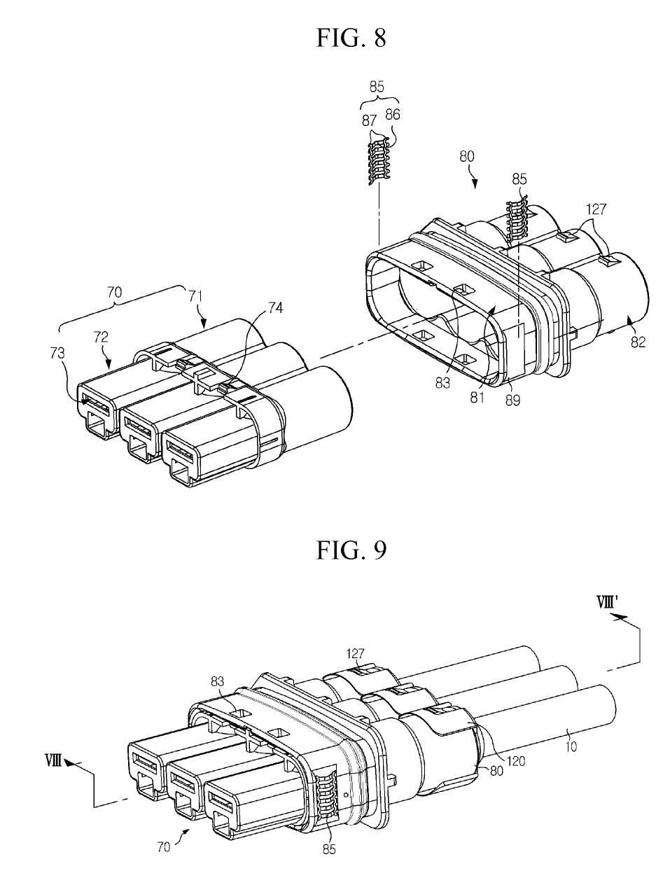

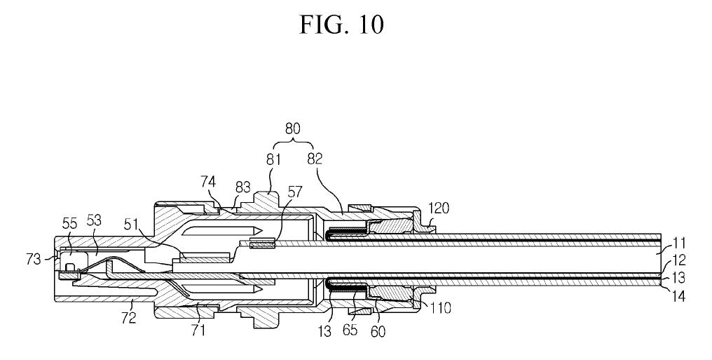

FIG. 8 is an exploded perspective view showing a first connector according to a second embodiment of the present invention, FIG. 9 is a perspective view showing that a shield cable is connected to the first connector shown in FIG. 8, and FIG. 10 is a sectional view taken along the line VIII-VIII′ of FIG. 9. The same components shown in FIGS. 8 to 10 as them of FIGS. 1a to 7 are indicated using the same reference numerals.

Meanwhile, though it has been illustrated above that the first connector is configured to have the outer housing 90 or the outer housing 90 and the lever 130, the first connector may be configured not to have the outer housing 90 and the lever 130 as shown in FIGS. 8 to 10 as an alternative.

In this case, the fixing protrusion 74 of the inner housing 70 is coupled to the fixing protrusion placing groove 83 of the shield shell 80, the inner housing fixing unit 81 and the inner housing 70 are inserted into the corresponding shield shell 180, and the elastic contact piece 85 presses the inner surface of the corresponding shield shell 180. In addition, in this embodiment, since the corresponding shield shell 180 is not inserted into the outer housing 90, there is no need to mount the elastic contact piece 185 to a part of the outer portion of the corresponding shield shell.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A shield connector for receiving a connection terminal coupled to a central line of a shield cable and protecting the central line and the connection terminal against noises generated from outside, the shield connector comprising:
an inner housing for receiving the central line of the shield cable and the connection terminal coupled to the central line, the inner housing fixing a part of the connection terminal; and
a shield shell for receiving at least a part of the inner housing and at least a part of the shield cable, the shield shell being electrically connected to a shield layer of the shield cable.

2. The shield connector according to claim 1, further comprising:
an outer housing provided in a cylindrical shape with openings at both ends thereof, the outer housing having a space therein such that the shield shell is inserted and fixed therein.

3. The shield connector according to claim 1 or 2, further comprising:
an elastic contact piece mounted to a part of an outer surface of the shield shell to be elastically transformed in an outer direction thereof.

4. The shield connector according to claim 1 or 2, wherein the shield shell includes:
an inner housing fixing unit for fixing the inner housing; and
a connection unit for receiving at least a part of the shield layer exposed out, the connection unit being made of conductive material and electrically coupled with the shield layer.

5. The shield connector according to claim 1 or 2, wherein the connection terminal includes:
a connection unit connected to the central line of the shield cable; and
a terminal head extended from the connection unit to receive a conductive matter inserted from outside.

6. The shield connector according to claim 1 or 2,
wherein the shield layer of the shield cable is connected to the shield shell using a connection member, and
wherein the connection member includes:
a connection ring having an inner diameter corresponding to an outer diameter of the shield layer, the connection ring partially having an outer diameter corresponding to a shortest distance between inner surfaces of the shield shell; and
a compression ring having a hollow with a size capable of receiving the connection ring and the shield layer that is rolled up on the outer surface of the connection ring.

7. The shield connector according to claim 1 or 2, further comprising:
a seal ring member having a hollow with an inner diameter corresponding to an outer diameter of the shield cable, the seal ring member having an outer diameter corresponding to an inner diameter of the shield shell.

8. The shield connector according to claim 6, further comprising:
a stopper mounted to a part of the shield cable such that the connection member and the shield layer of the shield cable that are inserted into an inner space of the shield shell are not deviated from the inner space of the shield shell.

9. A shield connector, comprising:
a corresponding connection terminal having a core line connection unit connected to an exposed core line of a cable and a contact pin formed at an opposite end to the core line connection unit;
a corresponding inner housing having a hollow capable of receiving the corresponding connection terminal and the cable therein; and
a corresponding shield shell made of conductive material and having a hollow capable of receiving the corresponding inner housing therein.

10. The shield connector according to claim 9, further comprising:
an elastic contact piece mounted to an outside of the corresponding shield shell to be elastically transformed in an outer direction thereof.

11. The shield connector according to claim 9 or 10, further comprising:
a seal ring member having a hollow with an inner diameter corresponding to an outer diameter of the cable, the seal ring member having an outer diameter corresponding to an inner diameter of the corresponding inner housing.

12. The shield connector according to claim 9 or 10, further comprising:
a stopper mounted to a part of the cable such that at least a core line of the cable and the corresponding connection terminal that are inserted into an inner space of the corresponding inner housing are not deviated from the inner space of the corresponding inner housing.

13. A shield connector set including first and second connectors that are coupled with each other,
wherein the first connector includes:
a connection terminal having a connection unit connected to an exposed central line of a shield cable and a terminal head extended from the connection unit to receive a conductive matter inserted from outside;
a connection member installed to an exposed shield layer of the shield cable;
an inner housing for receiving the connection unit of the connection terminal therein, the inner housing having a central line protecting unit for intercepting an electric contact to the connection unit of the connection terminal from outside and a terminal fixing unit integrated with the central line protecting unit to insert and fix the terminal head therein; and
a shield shell for fixing at least the inner housing and the shield cable to which the connection member is mounted,
wherein the second connector includes:
a corresponding connection terminal having one end connected to a core line of a cable and the other end inserted into the terminal head;
a corresponding inner housing having a hollow capable of receiving the corresponding connection terminal and the cable therein; and
a corresponding shield shell having a hollow capable of receiving the corresponding inner housing therein.

14. The shield connector set according to claim 13,
wherein the first connector further includes an outer housing having a cylindrical shape with opening at both ends thereof, the outer housing having a space therein such that the shield shell is inserted and fixed therein,
wherein the second connector further includes an elastic contact piece mounted to an outside of the corresponding shield shell to be elastically transformed in an outer direction thereof, and
wherein the corresponding shield shell is partially inserted into the outer housing such that the elastic contact piece pressures an inner surface of the outer housing.

15. The shield connector set according to claim 13 or 14,
wherein the first connector further includes an elastic contact piece mounted to the shield shell to be elastically transformed in an outer direction of the shield shell.

16. The shield connector set according to claim 13 or 14, wherein the shield shell includes:
an inner housing fixing unit for fixing the inner housing; and
a connection unit for receiving a part of the connection member therein, the connection unit being contacted with the connection member.

17. The shield connector set according to claim 14,
wherein the outer housing has at least one fixing protrusion protruded inwards, and
wherein the shield shell has a fixing protrusion placing groove capable of receiving the fixing protrusion.

18. The shield connector set according to claim 13 or 14, wherein the connection member includes:
a connection ring having an inner diameter corresponding to an outer diameter of the shield layer, and connection ring partially having an outer diameter corresponding to a shortest distance between inner surfaces of the shield shell; and
a compression ring having a hollow capable of receiving the connection ring and the shield layer that is rolled up on the outer surface of the connection ring.

19. The shield connector set according to claim 13 or 14,
wherein the first connector further includes a seal ring member having a hollow with an inner diameter corresponding to an outer diameter of the shield cable, the seal ring member having an outer diameter corresponding to an inner diameter of the shield shell.

20. The shield connector set according to claim 13 or 14,
wherein the first connector further includes a stopper mounted to a part of the shield cable such that the shield layer of the shield cable and the connection member that are inserted into an inner space of the shield shell are not deviated from the inner space of the shield shell.

21. The shield connector set according to claim 13 or 14,
wherein the second connector further includes a seal ring member having a hollow with an inner diameter corresponding to an outer diameter of the cable, the seal ring member having an outer diameter corresponding to an inner diameter of the corresponding inner housing.

22. The shield connector set according to claim 13 or 14,
wherein the second connector further includes a stopper mounted to a part of the cable such that the core line of the cable and the corresponding connection terminal that are inserted into an inner space of the corresponding inner housing are not deviated from the inner space of the corresponding inner housing.
